(19) United States
(12) Patent Application Publication
(10) Pub. No.: US 2011/0022335 A1
(43) Pub. Date: Jan. 27, 2011

(54) REAL-TIME NON-STATIONARY FLOWMETER

(76) Inventors: Eric Foucault, Poitiers (FR); Philippe Laurent Micheau, Sherbrooke (CA); Philippe Szeger, Saint Julien L'Ars (FR); Janki Laumonier, Poitiers (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/934,990

(22) PCT Filed: Mar. 23, 2009
(86) PCT No.: PCT/EP09/53380

§ 371 Date: Sep. 27, 2010

(30) Foreign Application Priority Data
Mar. 28, 2008 (FR) 08/52026

(51) Int. Cl. G01F 1/44

(52) U.S. Cl. 702/47; 73/861.63

(57) ABSTRACT

The invention concerns a system for real-time measurement of the instantaneous flow rate of a fluid with steady or unsteady flow in a conduit, comprising a flow member (1) for the fluid provided with at least two wall pressure taps (A,B), means (2) to measure pressure difference coupled with the two pressure taps (A,B), and programmed computing means (3) for real-time computing of flow rate by solving a nonlinear, ordinary, differential equation relating instantaneous flow rate to pressure difference, the pressure difference in said formula being positive or negative in relation to the variation in flow velocity of the fluid in the conduit and/or to the direction of flow of the fluid, characterized in that the flow member (1) comprises a filter (4) positioned between the two pressure taps (A,B) to increase pressure drop.

The field concerned by the present invention is the measurement of the instantaneous flow rate of a fluid with unsteady flow.

It notably finds application, but is not limited thereto, in the areas of process engineering and the automotive industry.

More particularly, it advantageously finds application in the control and regulation of heat engines, test centres and research laboratories, and all current applications of prior art flowmeters.

More particularly, it advantageously finds application in all situations in which flow is unsteady, and therefore knowledge of flow rate requires the integration of velocity in time and space.

### STATE OF THE ART

Measurements of flow rates are elements essential to the implementing and optimizing of industrial processes.

At the present time, to determine the flow rate of a fluid with unsteady flow at a given time it is generally necessary to use measurement techniques allowing the velocity of this fluid to be determined. Once a set of velocities has been determined for different times, this set of velocities is spatially integrated in order to determine the trend in flow rate as a function of time.

A certain number of systems and methods have already been proposed which can be used to obtain the flow rate of a fluid with unsteady flow, by determining the velocity of this fluid.

As an example, so-called Particle Image Velocimetry methods (PIV) can be cited or so-called Laser Doppler Velocimetry (LDV) methods, and the systems associated therewith. These methods are based on measurement of the movement of small particles contained in the flowing fluid, this movement being measured using an image processing technique or by Doppler frequency processing.

However, these methods and systems have a certain number of drawbacks. In particular, the PIV and LDV methods do not allow real-time determination of the flow rate of a fluid, since these techniques require post-processing of the acquired images in order to obtain the velocity of the fluid. In addition, the application of said techniques is cumbersome and costly. These methods also have poor time resolution and therefore have a narrow bandwidth (generally less than 10 Hz for the PIV method).

Another method to obtain the flow rate of a fluid having unsteady flow, from the velocity thereof, uses a Pitot tube (or Prandtl probe).

A Pitot tube is an instrument intended to be immersed in a conduit to determine the velocity of a flowing fluid by measuring a difference in pressure. However, the direction of flow must be known and constant in order to set up a Pitot tube. Additionally, when the direction of flow varies, measurement of total pressure is impossible leading to errors when measuring speed. Finally, this type of system is intrusive and therefore perturbs flow.

The flow rate of a fluid with unsteady flow can also be obtained from its velocity by using a hot wire or hot film system placed in the flowing fluid. However, said method gives point measurement and is insensitive to the direction of flow of the fluid. In addition, its implementation is complex and costly, notably because the heating wire or film is very fragile and ages rapidly requiring regular maintenance. Finally it is an intrusive method which therefore modifies the flow.

To overcome the disadvantages of the methods presented above, a particular measurement system has been developed which allows real-time measurements of the instantaneous flow rate of a flowing fluid, and takes into account the direction of flow of the fluid. This system and associated measurement method are more particularly described in application PCT/FR2005/000352 published on Sep. 1, 2005 under reference WO 2005/080924 which is incorporated herein by reference. Said system performs particularly well for the measurement of the instantaneous flow rate of a fluid whose flow varies at a high frequency of several tens of Hertz. However, it has some shortcomings notably related to the space taken up by the proposed system.

One object of the present invention is therefore to provide a system for the real-time measurement of the flow rate of fluid with unsteady flow, which can be used to solve most of the above-cited drawbacks.

### DISCLOSURE OF THE INVENTION

For this purpose, a system is proposed for real-time measurement of the instantaneous flow rate of a fluid with steady or unsteady flow in a conduit, comprising a fluid flow member provided with at least two wall pressure taps, means to measure pressure difference coupled with the two pressure taps, and programmed computing means to compute the flow rate in real-time by solving a nonlinear, ordinary differential equation which relates instant flow rate to pressure difference, the pressure difference in said formula being positive or negative in relation to the variation in the velocity of fluid flow in the conduit and/or to the direction of flow of the fluid, characterized in that the flow member comprises a filter positioned between the two pressure taps to increase pressure loss.

Preferred, but non-limiting, aspects of this measurement system are the following:
the flow member has cylindrical geometry with a circular cross-section of constant diameter;
the flow member has frustoconical geometry of Venturi type;
the flow member comprises two additional filters respectively arranged upstream and downstream of the flow member relative to the flow of the fluid, to condition the flow;
the filter(s) are arranged substantially perpendicular to the axis of the flow member;
the filter(s) are grids;
the filter(s) have a honeycomb structure;
the filter(s) are formed in a porous material,
the flow member further comprises one or more temperature measurement probes coupled with the computing means;
the flow member further comprises a static pressure measurement probe coupled with the computing means.

### DESCRIPTION OF THE FIGURES

Other characteristics and advantages of the invention will become further apparent from the following description which is solely illustrative and is non-limiting, and is to be read with reference to the appended drawings in which:

FIG. 1 is a schematic illustration of a system to measure the instantaneous flow rate of a fluid, according to the invention;

FIG. 2 is a graph allowing a comparison between the flow rate measured with a system according to the invention and the flow rate measured using a hot wire system.

### DETAILED DESCRIPTION OF THE INVENTION

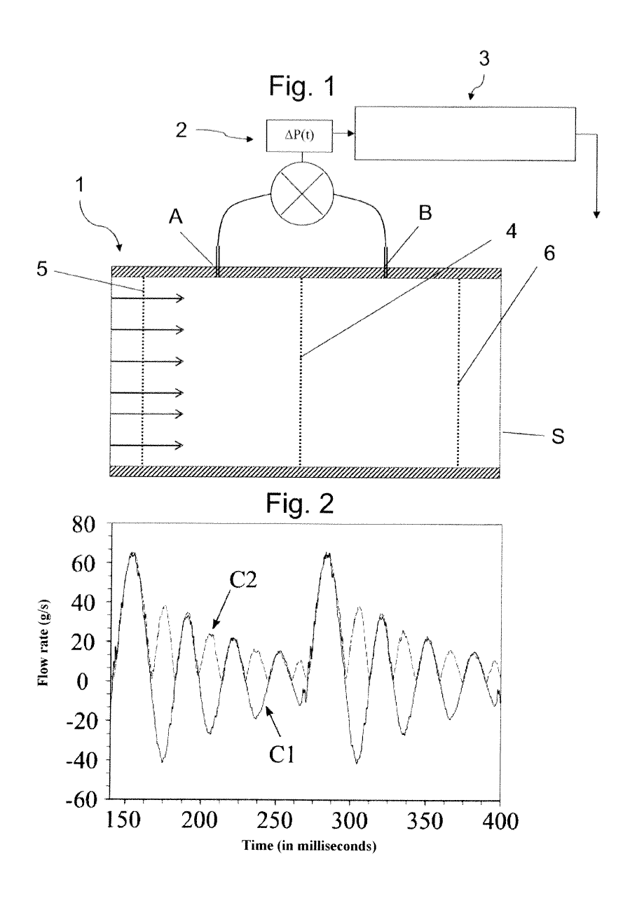

FIG. 1 schematically illustrates the proposed system, capable of measuring the flow rate of a fluid in a conduit in real-time using pressure difference. This system is a flow meter and essentially comprises a flow member 1 intended to be inserted in the conduit, means 2 to measure pressure difference, and computing means 3 adapted to calculate flow rate in real-time from a pressure difference measured in the flow member.

The flow member 1 is of particularly simple shape adapted for easy insertion or inter-positioning in a conduit in which there is a flowing fluid whose instantaneous flow rate it is desired to measure.

More particularly, the flow member 1 comprises any inner cross-section S, the member possibly having cylindrical geometry. Preferably, the general shape of the flow member 1 is cylindrical with a circular cross-section of constant diameter, having the same characteristics as the conduit in which it is inserted. It may also be of frustoconical shape, thereby forming a Venturi.

Two static pressure taps A and B are placed on the wall of this flow member 1. These static pressure taps A and B are coupled with the measuring means 2 to measure a pressure difference in the system. The means 2 therefore allow the difference between the two static pressures P1 and P2 to be measured, tapped at A and B respectively. For example a differential pressure sensor is used.

The computing means 3 are electronic. These computing means 3 are programmed to apply a formula-solving algorithm explained below, which is a non-linear ordinary differential equation allowing calculation of instantaneous flow rate, the sign of this flow rate indicating the direction of flow. The electronic computer 3 is coupled with the differential pressure sensor 2, since this computer 3 computes the instantaneous flow rate from the pressure difference measured in the flow member 1, this difference also being instantaneous.

As indicated above, the first characteristic of the flow member 1 is that it is of cylindrical shape particularly easy to implement. The flow member may for example have a circular cross-section with constant diameter, which simplifies its implementation accordingly.

In addition, this flow member 1 integrates a filter 4 arranged on the pathway of the fluid inside the flow member 1, and positioned between the two pressure taps A and B. This filter 4 is designed to induce pressure loss in the flow member 1, more particularly between the pressure tap A and the pressure tap B, so as to set up a pressure difference between these two pressure taps A and B.

This filter 4 is therefore designed to set up an additional pressure loss in the flow member 1 in addition to normal pressure loss due to the geometry of the flow member 1, and more particularly at the walls thereof.

As is described in detail below, there is a relationship between pressure and instantaneous flow rate for a fluid with unsteady flow in a conduit, or more precisely a relationship between the pressure of the fluid and its acceleration and kinetic energy (which is directly related to pressure losses). The additional pressure loss added by the filter 4 allows the amount of kinetic energy of the flow to be balanced with respect to the acceleration of the fluid, so that it is possible to calculate the instantaneous flow rate of the fluid in the conduit more precisely from the measured pressure difference. The filter 4 therefore allows pressure loss to be adapted to the particular dynamics of the flow of the fluid.

The filter 4 may have any arrangement, shape and structure provided it allows the introduction of a homogeneous pressure loss between the two pressure taps A and B.

Preferably, a filter 4 is used whose cross-section substantially corresponds to the inner cross-section S of the flow member 1, so that it covers practically the entirety of this inner cross-section S. In addition, the filter 4 is preferably arranged substantially perpendicular to the flow of the fluid in the flow member 1, this fluid flow being schematically illustrated in FIG. 1 by black arrows.

The filter 4 may be in the form of a grid for example. This filter 4 may have a honeycomb structure. Provision may also be made for this filter 4 to be fabricated in a porous material.

The flow rate measurement system presented is therefore particularly easy to design and implement. This is notably the case when the flow member 1 consists of a cylindrical portion with circular cross-section of constant diameter, thereby forming a tube whose dimensions substantially correspond to the dimensions of the conduit inside which the fluid to be measured circulates, and when a simple filter 4 is inserted inside this cylindrical portion.

In addition, said configuration has other notable advantages compared with prior art devices. In particular, this system is of symmetrical configuration which firstly allows its simplified insertion in the fluid flow conduit. Also, this provides functioning and reliability that are independent of the direction of flow of the fluid within the conduit. This symmetry in the geometry of the flow member 1 effectively implies that the measurement system is scarcely sensitive to upstream and downstream conditions since the filter 4 has exactly the same effects in terms of pressure loss irrespective of the direction of fluid flow under consideration. The accuracy of the measurement system is therefore independent of the direction of flow, which is of particular advantage in some areas of application such as the automotive industry in which some flows e.g. heat engine intake flows, may periodically change direction.

Another advantage induced by this particular configuration of the flow member 1 lies in the small bulk of the corresponding measurement system. The length of the flow member 1 can be substantially reduced compared, for example, with systems based on particular velocity profiles (of Venturi type for example) which require the design of flow members having ad hoc geometry, with conduits upstream and downstream of the measurement area having sufficient lengths to condition the flow.

The use of a filter 4 in the flow member 1 has the further advantage of reducing perturbations of the flowing fluid, which makes the pressure measurements more reliable.

The flow member 1 may also comprise additional filters 5 and 6 respectively arranged upstream and downstream of the flow member 1 relative to the main direction of fluid flow. Said filters 5 and 6 may have the same shape, structure and arrangement as the filter 4 arranged between the pressure taps A and B.

With these upstream 5 and downstream 6 filters, it is possible to circumvent any large-scale, fluid flow structures. If the fluid flow contains vortex structures of large size, then the filters 5 and 6 placed at the two ends of the flow member 1 allow the flow of fluid to be conditioned i.e. they can stabilize and regularize the flow of fluid inside the flow member so that pressure measurements are even further reliable.

This solution therefore allows reliable measuring of the instantaneous flow rate of a fluid, irrespective of the general flow structure of said fluid, whilst maintaining much reduced space requirements. The proposed solution does not require the length of the flow member 1 to be increased to achieve flow regulation.

The operating principle of the measurement system in FIG. 1 is the following. The fluid flows in a conduit and passes into the flow member 1.

The means 2 measuring pressure difference measure the difference between the static pressure P1 acquired at pressure tap A and the static pressure P2 acquired at pressure tap B. The difference in pressure measured by the measurement means 2 is transmitted to the input of the computing means 3.

The computing means 3 compute the fluid flow rate in real time from the pressure difference received at their input. As already mentioned, the computing means 3 are adapted to solve the formula relating flow rate to pressure difference, this formula allowing real-time calculation of the flow rate and also giving the direction of flow of the fluid.

At the output of the computing means 3, the fluid flow rate is obtained in real time, even for an unsteady flow.

With the device in FIG. 1, it is therefore possible to measure the unsteady flow rate of a fluid in a conduit. The measurement of this flow rate only requires two static pressure measurements, the corresponding pressure difference being obtained for example by a single differential pressure sensor 2 coupled with the pressure taps, or by two relative (or absolute) pressure sensors.

As indicated above, the real-time computing of the flow rate of a fluid is calculated using the relationship established between instantaneous flow rate and pressure, for a fluid with unsteady flow in a conduit. It is recalled that the value of this flow rate can be positive or negative, which means that the sign of the calculated flow rate indicates the direction of flow of the fluid.

Said relationship was already established for the real-time unsteady flowmeter described in the PCT publication published under reference WO 2005/080 924, to which helpful reference can be made for a detailed explanation.

The formula used for the present flow rate measurement system is given by a nonlinear, ordinary differential equation, of the following general form:

K₁·dq(t)/dt+K₂·f(q(t))=ΔP(t) [Equation 1]

in which:
q(t) represents the general form of the desired instantaneous flow rate,
K₁ and K₂ are constants,
dq(t)/dt represents the derivative, in relation time, of the desired flow rate,
f(q(t)) is the nonlinear function of the instantaneous volume flow rate,
ΔP(t) is the measured pressure difference.

Therefore, if the desired instantaneous mass flow rate is denoted qm(t), and the desired instantaneous volume flow rate is denoted qv(t), Equation 1 can be written: either:

k₁·dqₘ(t)/dt+k₂·f(qₘ(t))/rho=ΔP(t) [Equation 2]

or:

k₁·dqᵥ(t)/dt+k₂·f(qᵥ(t))=ΔP(t)/rho [Equation 3]

in which:

k₁ and k₂ are constants determined by calibration,

rho is the density of the fluid with qm(t)=rho·qv(t)

For f(q(t)) which is a nonlinear function of the instantaneous volume flow rate, it is possible for example to use:

f(q(t))=|q(t)|·q(t) [Equation 4])

The presence of terms in the formulas whose sign varies in relation to the variation in flow velocity of the fluid in the conduit and/or in relation to the direction of flow (terms dq(t)/dt and ΔP(t)), and of a term whose sign varies in relation to the direction of the flow of the fluid in the conduit (term f(q(t))) allows the calculation of a positive or negative flow rate whose sign indicates the direction of flow of the fluid. In particular, in the above-described formulas, the term ΔP(t) is taken into account as such, with no absolute value. The sign allocated to pressure difference IP(t) particularly varies in relation to the variation in flow velocity of the fluid and/or the direction of flow of the fluid. The pressure difference ΔP(t) is therefore positive or negative, for example when the fluid flowing in the conduit accelerates or decelerates, and/or when the fluid flows in the conduit in one direction or in the opposite direction. Also, in the foregoing formulas, the terms dq(t)/dt and f(q(t)) are also taken into account as such, with no absolute value.

The sign of the calculated flow rate gives an indication of the direction of flow, and the sign inversions of the calculated flow rate give an indication of reversed direction of flow of the fluid. The formulated, nonlinear, ordinary differential equations have the remarkable property of converging at all times towards a bounded solution, provided that the initial condition is suitably chosen in the order of magnitude of the flow rate to be found. Preferably, as initial condition q(t=0)=0 is chosen. In practice, when the initial condition is correctly chosen, the output signal from the computer 3 converges towards the instant value of the desired flow rate.

The solving algorithm can be given both numerical and analogue use, and allows the value of instantaneous flow rate to be obtained in real-time.

The flow rate measured with this method corresponds to the flow rate q(t) of an incompressible fluid with unsteady flow in a conduit. The density of the fluid is a data item which must be known to solve the above Equations 1, 2 or 3. It is to be noted that it is itself function of a certain number of other physical magnitudes such as temperature, static pressure and optionally molar mass of the fluid.

In cases when the compressibility of the fluid cannot be neglected, a temperature measurement probe and/or a probe measuring the static pressure prevailing in the flow is integrated in the measurement system, making it possible to take into account the density fluctuations in the fluid flow under consideration.

If it is possible, using third means, to determine the instant value of the absolute value of the volume flow rate |qv|, then the proposed instrument can be used to deduce therefrom the instantaneous mass flow rate qₘ (but this time with its direction), independently of any fluctuations in density rho, which in this case does not need to be determined. This is shown by Equation 5 drawn from Equations 2 and 4:

k₁·dqₘ(t)/dt+k₂·qₘ(t)·|qv(t)|=ΔP(t) [Equation 5]

Similarly if it is possible, using third means, to determine a statistical magnitude related to the absolute value of the volume flow rate |qᵥ|, such as the mean value (or effective value) of volume flow rate |qᵥ|, then the proposed instrument can be used to deduce therefrom the instantaneous mass flow rate qm (with its direction) independently of any slow fluctuations in density rho, which no longer needs to be determined in this case. This is shown by Equation 6, drawn from Equations 2 and 4:

k₁·dqₘ(t)/dt+₂·qₘ(t)·|qₘ(t)|·<|qᵥ(t)|>/<|qₘ(t)|>=ΔP(t) [Equation 6]

in which < > represents the arithmetic mean operator; <|q(t)|> therefore represents the mean value of the absolute value of the flow rate during a certain lapse of time.

The graph in FIG. 2 gives the results of the measurement of instantaneous flow rate obtained using the system in FIG. 1. More precisely, this graph shows the trend in pulsed flow rate within an intake pipe of a single-cylinder heat engine, measured using the proposed system, and compared with the flow rate reconstructed from the velocity of the fluid as determined using a hot wire system.

The first curve C1 and the second curve C2 in FIG. 2 show the trend in flow rate in a pipe as a function of time. The solid lines (curve C1) represent the results obtained with the proposed system, whilst the dotted lines (curve C2) represent the results obtained with the hot wire measuring system.

It can be noted on curve C2 that the hot wire measurement system, which is incapable by design of giving the direction of flow, always gives a positive flow rate even when flow is reversed. This is not the case with the system of the present invention which fully follows the reversals in the direction of flow as can be seen on curve C1. This is due to the fact that the measurement system of the present invention takes into account the direction of flow.

The proposed system has very good time resolution (large bandwidth) since it has been successfully tested up to a speed of 3000 revs/minute. Curve C1 shows the trend in flow rate for an idling speed of 900 revs/minute. Therefore the proposed system has high time resolution comparable with that of hot wire or film systems, without having their numerous shortcomings.

The reader will appreciate that numerous modifications can be made hereto without departing materially from the novel teachings and advantages described herein. Therefore any modifications of such type are to be incorporated within the scope of the measurement system according to the invention.

1. A real-time measurement system of the instantaneous flow rate of a fluid with steady or unsteady flow in a conduit, comprising a flow member (1) for the fluid provided with at least two wall pressure taps (A,B), measuring means (2) to measure pressure difference coupled with the two pressure taps (A,B) and computing means (3) programmed for real-time computing of flow rate by solving a nonlinear, ordinary, differential equation relating instantaneous flow rate to pressure difference, the pressure difference in said formula being positive or negative in relation to the variation in flow velocity of the fluid in the conduit and/or to the direction of flow of the fluid, wherein the flow member (1) comprises a filter (4) positioned between the two pressure taps (A,B) to increase pressure drop.

2. The system of claim 1, wherein the flow member (1) has cylindrical geometrya circular cross-section (S) of constant diameter.

3. The system of claim, wherein the flow member (1) has frustoconical geometry of Venturi type.

4. The system of claim 1, wherein the flow member (1) comprises two additional filters (5,6) respectively arranged upstream and downstream of the flow member (1) relative to the flow of fluid, so as to condition the flow.

5. The system of claim 1, wherein the filter(s) (4,5,6) are arranged substantially perpendicular to the axis of the flow member.

6. The system according of claim 1, wherein the filter(s) (4,5,6) are grids.

7. The system of claim 1, wherein the filter(s) (4,5,6) have a honeycomb structure.

8. The system of claim 1, wherein the filter(s) (4,5,6) are formed in a porous material.

9. The system according of claim 1, wherein the flow member (1) further comprises one or more temperature measurement probes coupled with the computing means (3).

10. The system of claim 1, wherein the flow member (1) further comprises a static pressure measurement probe coupled with the computing means (3).
